(19) United States
(12) Patent Application Publication
(10) Pub. No.: US 2021/0375248 A1
(43) Pub. Date: Dec. 2, 2021

(54) SOUND SIGNAL SYNTHESIS METHOD, GENERATIVE MODEL TRAINING METHOD, SOUND SIGNAL SYNTHESIS SYSTEM, AND RECORDING MEDIUM

(71) Applicant: YAMAHA CORPORATION, Hamamatsu-shi (JP)

(72) Inventors: Jordi BONADA, Barcelona (ES); Merlijn BLAAUW, Barcelona (ES); Ryunosuke DAIDO, Hamamatsu-shi (JP)

(21) Appl. No.: 17/405,388

(22) Filed: Aug. 18, 2021

Related U.S. Application Data
(63) Continuation of application No. PCT/JP2020/006158, filed on Feb. 18, 2020.

(30) Foreign Application Priority Data
Feb. 20, 2019 (JP) 2019-028681

(51) Int. Cl. G10H 7/10; G10H 7/00; G06N 20/20

(52) U.S. Cl. CPC G10H 7/105; G10H 7/002; G10H 2210/325; G10H 2250/311; G10H 2250/235; G06N 20/20

(57) ABSTRACT

A computer-implemented sound signal synthesis method includes: generating, based on first control data representative of a plurality of conditions of a sound signal to be generated, (i) first data representative of a sound source spectrum of the sound signal, and (ii) second data representative of a spectral envelope of the sound signal; and synthesizing the sound signal based on the sound source spectrum indicated by the first data and the spectral envelope indicated by the second data.

### CROSS REFERENCE TO RELATED APPLICATIONS

This application is a Continuation application of PCT Application No. PCT/JP2020/006158, filed on Feb. 18, 2020, and is based on and claims priority from Japanese Patent Application No. 2019-028681, filed on Feb. 20, 2019, the entire contents of each of which are incorporated herein by reference.

### BACKGROUND

### Technical Field

The present invention relates to sound source technology for synthesizing sound signals.

### Description of Related Art

Various sound synthesis techniques have been proposed by which a sound signal is generated using a neural network.

For example, Non-Patent Document 1 (Jonathan Shen, Ruoming Pang, Ron J. Weiss, and et al, “Natural TTS Synthesis by Conditioning WaveNet on Mel Spectrogram Predictions, <URL: https://arxiv.org/abs/1712.05884>.) discloses a technique for synthesizing sound.

In Non-Patent Document 1, a series of spectra is generated by inputting a series of texts into a neural network (a generative model), and the generated series of spectra is input into another neural network (a neural vocoder) to synthesize a series of sound signals representative of sound corresponding to the series of texts.

Non-Patent Document 2 (Merlijn Blaauw and Jordi Bonada, “A Neural Parametric Singing Synthesizer Modeling Timbre and Expression from Natural Songs”, <URL: https://www.mdpi.com/2076-3417/7/12/1313>.) discloses a technique for synthesizing sound. In the technique of Non-Patent Document 2, a series of control data including pitches of notes in a tune, etc., is input into a neural network (a generative model), to generate (i) a series of spectral envelopes representative of harmonic components, (ii) a series of spectral envelopes representative of non-harmonic components, and (iii) a series of pitches F0. Then the generated (i) to (iii) are input into a vocoder to synthesize a sound signal.

### SUMMARY

To generate a high quality sound signal over a certain pitch range using the generative model disclosed in Non-Patent Document 1, it is necessary to advance train the generative model with training data that includes data for a variety of pitches within the pitch range. This approach requires use of a large amount of data. To solve this problem, a method can be conceived by which an amount of training data is increased by generating training data for one pitch based on training data for another pitch. However, if such methods for processing sound signals are used, a deterioration in quality occurs. In particular, if a sound signal is pitch-changed using resampling, a time length and a series of spectral envelopes of the sound signal are changed from the original time length and series of spectral envelopes of the sound signal. Further, if the sound signal is pitch-changed using a sound process, such as Pitch Synchronous Overlap and Add (PSOLA), a modulation frequency of the sound signal is changed from the original modulation frequency of the sound signal.

A pitch F0 and two types of spectral envelopes are generated by the generative model disclosed in Non-Patent Document 2. In general, the shapes of spectral envelopes do not significantly change even when a pitch changes, which allows an amount of training data to be increased with ease. In an example of a case where no training data (a spectral envelope) for an intended pitch is prepared, if training data for a pitch next to the intended pitch is used as it stands, or if the intended pitch is interpolated using respective training data for respective pitches that are present on each side of the target pitch, a deterioration in quality is small.

However, in the technique of Non-Patent Document 2, although the pitch F0 and the harmonic components generated from a spectral envelope representative of harmonic components are of relatively high quality, it is difficult to improve a quality of non-harmonic components generated from a spectral envelope representative of non-harmonic components.

A computer-implemented sound signal synthesis method according to one aspect of the present disclosure includes: generating, based on first control data representative of a plurality of conditions of a sound signal to be generated, (i) first data representative of a sound source spectrum of the sound signal, and (ii) second data representative of a spectral envelope of the sound signal; and synthesizing the sound signal based on the sound source spectrum indicated by the first data and the spectral envelope indicated by the second data.

A computer-implemented generative model training method according to one aspect of the present disclosure includes: obtaining, from a waveform spectrum of a reference signal, a spectral envelope representative of an envelope of the waveform spectrum; obtaining a sound source spectrum by applying whitening to the waveform spectrum, using the spectral envelope; and training a generative model that includes at least one neural network, in which the generative model is trained to generate, based on first control data representative of a plurality of conditions of the reference signal, first data representative of the sound source spectrum and second data representative of the spectral envelope.

A sound signal synthesis system according to one aspect of the present disclosure includes: at least one processor communicatively connected to a memory and configured to execute a program to: generate, based on first control data representative of a plurality of conditions of a sound signal to be generated, (i) first data representative of a sound source spectrum of the sound signal, and (ii) second data representative of a spectral envelope of the sound signal; and synthesize the sound signal based on the sound source spectrum indicated by the first data and the spectral envelope indicated by the second data.

A non-transitory recording medium for storing a program executable by a computer to execute a method, according to one aspect of the present disclosure, includes generating, based on first control data representative of a plurality of conditions of a sound signal to be generated, (i) first data representative of a sound source spectrum of the sound signal, and (ii) second data representative of a spectral envelope of the sound signal; and synthesizing the sound signal based on the sound source spectrum indicated by the first data and the spectral envelope indicated by the second data.

### BRIEF DESCRIPTION OF THE DRAWINGS

FIG. 1 is a block diagram showing a configuration of a sound signal synthesis system.

FIG. 2 is a block diagram showing a functional configuration of the control device.

FIG. 3 is a flowchart showing a preparation process.

FIG. 4 is a diagram explaining whitening.

FIG. 5 is an example of a series of waveform spectra of a sound signal in a pitch.

FIG. 6 is an example of a series of ST representations for the sound signal.

FIG. 7 is a diagram explaining a trainer and a generator.

FIG. 8 is an example of the generated series of ST representations in another pitch.

FIG. 9 is a flowchart of a sound generation process.

FIG. 10 is an explanatory drawing of an example of a converter.

FIG. 11 is a diagram explaining another example of a converter.

FIG. 12 is a diagram explaining a trainer and a generator.

FIG. 13 is a diagram explaining a trainer and a generator.

### DESCRIPTION OF THE EMBODIMENTS

### A: First Embodiment

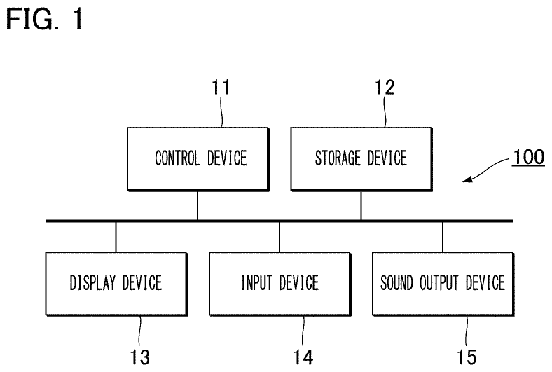

FIG. 1 is a block diagram showing an example configuration of a sound signal synthesis system 100 of the present disclosure. The sound signal synthesis system 100 is realized by a computer system that includes a control device 11, a storage device 12, a display device 13, an input device 14, and a sound output device 15. The sound signal synthesis system 100 is, for example, an information terminal, such as a portable phone, smart phone, personal computer, or other similar devices. The sound signal synthesis system 100 can be realized as a single device, or as a plurality of separately configured devices (e.g., a server client system).

The control device 11 comprises one or more processors that control each of the elements that constitute the sound signal synthesis system 100. Specifically, the control device 11 is constituted of different types of processors, such as a Central Processing Unit (CPU), Sound Processing Unit (SPU), Digital Signal Processor (DSP), Field Programmable Gate Array (FPGA), Application Specific Integrated Circuit (ASIC), and the like. The control device 11 generates a time-domain sound signal V representative of a waveform of the synthesized sound.

The storage device 12 comprises one or more memories that store programs executed by the control device 11, and various data used by the control device 11. The storage device 12 comprises a known recording medium, such as a magnetic recording medium, a semiconductor recording medium, or a combination of recording media. It is note of that the storage device 12 can be provided separate from the sound signal synthesis system 100 (e.g., a cloud storage), and the control device 11 can write and read data to and from the storage device 12 via a communication network, such as a mobile communication network or the Internet. In other words, the storage device 12 can be omitted from the sound signal synthesis system 100.

The display device 13 displays calculation results of a program executed by the control device 11. The display device 13 is, for example, a display. The display device 13 can be omitted from the sound signal synthesis system 100.

The input device 14 accepts a user input. The input device 14 is, for example, a touch panel. The input device 14 can be omitted from the sound signal synthesis system 100.

The sound output device 15 plays sound represented by a sound signal V generated by the control device 11. The sound output device 15 is, for example, a speaker or headphones.

For convenience, a D/A converter, which converts the digital sound signal V generated by the control device 11 to an analog sound signal V, and an amplifier, which amplifies the sound signal V, are not shown. In addition, although FIG. 1 illustrates a configuration in which the sound output device 15 is mounted to the sound signal synthesis system 100, the sound output device 15 can be provided separate from the sound signal synthesis system 100 and connected to the sound signal synthesis system 100 either by wire or wirelessly.

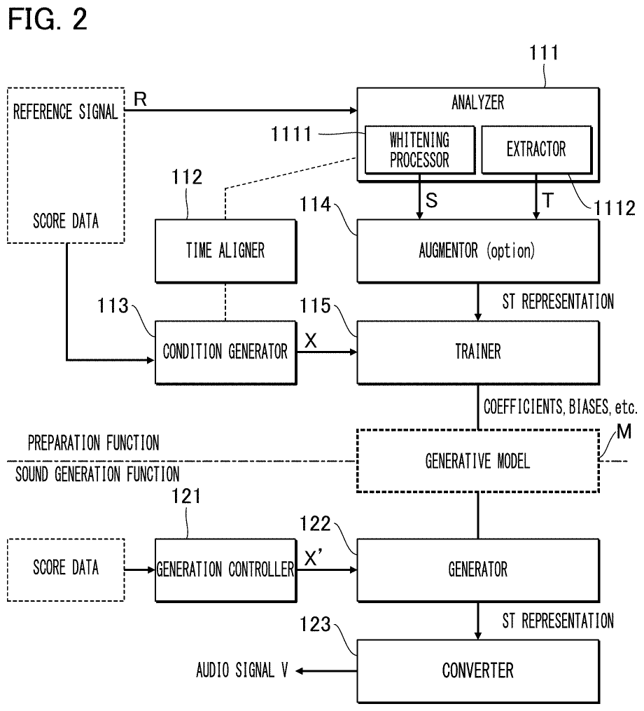

FIG. 2 is a block diagram showing an example of a functional configuration of the control device 11. By executing a program stored in the storage device 12, the control device 11 realizes a sound generation function (implemented by a generation controller 121, a generator 122, and a converter 123) that generates, by using a generative model M, a time-domain sound signal V representative of a sound waveform, such as a voice of a singer singing a song or a sound of an instrument being played. Furthermore, by executing a program stored in the storage device 12, the control device 11 realizes a preparation function (implemented by an analyzer 111, a condition generator 113, a time aligner 112, an extractor 1112, a subtractor, and a trainer 115) for preparing a generative model M used for generating sound signals V. The functions of the control device 11 can be realized by a set of multiple devices (i.e., a system), or some or all of the functions of the control device 11 can be realized by dedicated electronic circuitry (e.g., signal processing circuitry).

Description will first be given of Source Timbre Representation (hereafter, “ST representation”), a generative model M that generates an ST representation, and reference signals R used for training the generative model M. The ST representation refers to a feature amount representative of frequency characteristics of a sound signal V, and comprises a set of a sound source spectrum (a source) and a spectral envelope (a timbre). A case will be assumed in which a specific tone is added to a sound generated from a sound source. In this case, the sound source spectrum represents frequency characteristics of the sound produced by the sound source, and the spectral envelope represents frequency characteristics of the tone that is added to the sound. That is, the spectral envelope represents response characteristics of a filter that acts on the sound. A method of generating the ST representation from a sound signal will be described in detail in relation to the analyzer 111, which will be described later.

The generative model M is a statistical model for generating a series of ST representations (a series of sound source spectra S and a series of spectral envelopes T) for a sound signal V to be synthesized, in accordance with a series of control data X that specify conditions of the sound signal V. The generative characteristics of the generative model M are defined by variables (e.g., coefficients and biases) stored in the storage device 12. The statistical model is a neural network that generates (estimates) first data representative of a sound source spectrum S and second data representative of a spectral envelope T. The neural network can be a regression type, such as WaveNet™, which estimates a probability density distribution of a current sample based on more than one sample of previous sound signals V. The algorithm for generating the probability density distribution is freely selectable. Examples of the algorithm include Convolutional Neural Network (CNN) type, Recurrent Neural Network (RNN) type, and a combination of the two. The algorithm can be one that includes an additional element, such as Long Short-Term Memory (LSTM) or ATTENTION. The variables of the generative model M are established by training based on a training dataset prepared by a preparation function described below, and the generative model M in which the variables are established is used to generate a series of ST representations for the sound signal V to be synthesized, in a sound generation function described below. The generative model M in the first embodiment is a trained single model that has learned a relationship between (i) control data X and (ii) first data and second data.

To train the generative model M, the storage device 12 stores (i) score data, and (ii) sound signals R (hereafter, “reference signals R”) for respective score data. Each reference signal R represents a time-domain waveform obtained by a player playing a score of corresponding score data. The score data includes a series of notes.

A reference signal R corresponding to score data includes a series of waveform segments corresponding to a series of notes represented by the score. Each reference signal R is a time-domain signal representative of a sound waveform, and comprises a series of samples of sample cycles (e.g., at a sample rate of 48 kHz). The playing score can be realized by human instrumental playing, by singing by a singer, or by automated instrumental playing. Generation of a high quality sound by machine learning generally requires a large volume of training data obtained by advance recording of a large number of sound signals of a target instrument or a target player, etc., for storage in the storage device 12 as reference signals R.

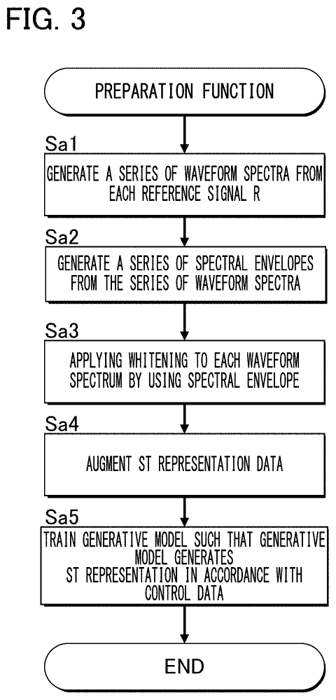

Next, the preparation function for training the generative model M shown in FIG. 2 will be described below. The preparation function is realized by a preparation process shown in the flowchart in FIG. 3, and is executed by the control device 11. In one example, the preparation process is initiated by an instruction from a user of the sound signal synthesis system 100.

When the preparation process is started, the control device 11 (implemented by the analyzer 111) generates a series of frequency-domain spectra (hereafter, “a series of waveform spectra”) from each of the reference signals R (Sa1). In one example, each waveform spectrum is an amplitude spectrum of the reference signal R. The control device 11 (implemented by the analyzer 111) generates a series of spectral envelopes from the series of waveform spectra (Sa2). In addition, the control device 11 (implemented by the analyzer 111) applies whitening to each of the series of waveform spectra using the series of spectral envelopes to output a series of sound source spectra (Sa3). The term whitening refers to a process used to reduce differences in intensity between different frequencies in the waveform spectrum.

Next, as for a missing pitch for which a corresponding control data has not been prepared, the control device 11 (implemented by an augmentor 114 in addition to the condition generator 113) uses control data X generated from score data corresponding to the reference signal R, to augment the series of sound source spectra and the series of spectral envelopes received from the analyzer 111 (i.e., data augmentation) (Sa4).

Next, the control device 11 (implemented by the condition generator 113 and the trainer 115) trains the generative model M using (i) the control data X, (ii) the series of sound source spectra and (iii) the series of spectral envelopes generated from the reference signals (including those generated by data augmentation), to establish the variables of the generative model M (Sa5).

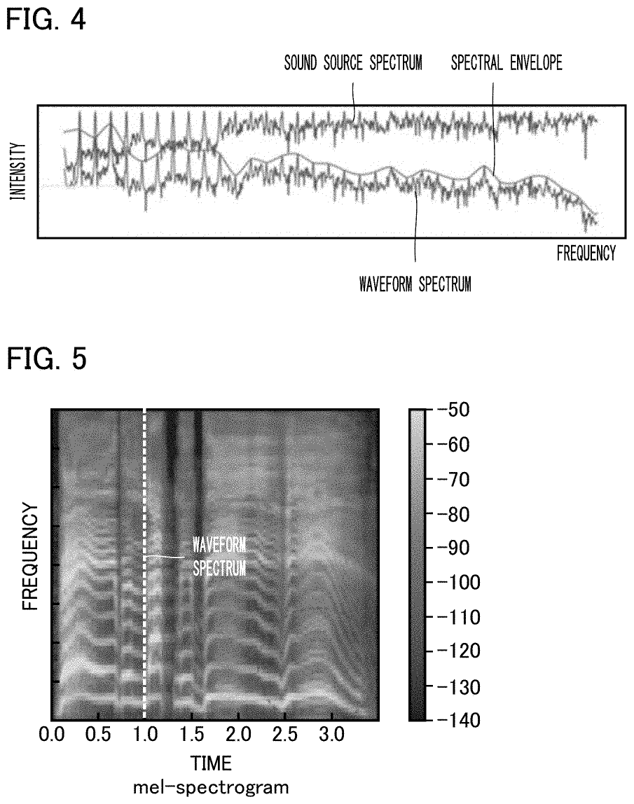

Detailed description will now be given of each function of the preparation process. The analyzer 111 shown in FIG. 2 includes an extractor 1112 and a whitening processor 1111. For each reference signal R for each score, the analyzer 111 calculates for each frame a waveform spectrum on the time axis. The analyzer 111 then calculates a series of ST representations (a series of sound source spectra and a series of spectral envelopes) from the calculated series of waveform spectra. FIG. 4 shows an example of (i) a waveform spectrum, (ii) a spectral envelope calculated from the waveform spectrum and (iii) a sound source spectrum calculated from the waveform spectrum. In one example, a known frequency analysis, such as Discrete Fourier Transform or the like, is used to calculate a waveform spectrum.

The extractor 1112 extracts a series of spectral envelopes from the series waveform spectra of a reference signal R. Any known technique can be used to extract the series of spectral envelopes. Specifically, the extractor 1112 obtains the series of amplitude spectra (the series of waveform spectra) by short-time Fourier transform, and extracts the peaks of the harmonic components from each amplitude spectrum. The extractor 1112 then calculates a series of spectral envelopes of the reference signal R by spline interpolation of the peak amplitudes. Alternatively, each waveform spectrum can be converted into cepstrum coefficients, the lower-order components of the cepstrum coefficients can be inverse-converted, and each amplitude spectrum obtained by the inverse-conversion can be used as the spectral envelope.

The whitening processor 1111 calculates for each reference signal R a series of sound source spectra by whitening (filtering) the reference signal R in accordance with the extracted series of spectral envelopes. Various whitening methods exist. The simplest method is to calculate, using a logarithmic scale, a sound source spectrum by subtracting each of the series of spectral envelopes from a corresponding waveform spectrum (e.g. the amplitude spectrum) of the reference signal R. In one example, a window width of the short-time Fourier transform is about 20 milliseconds, and a time difference between two consecutive frames is about 5 milliseconds.

The analyzer 111 can reduce a number of dimensions of each sound source spectrum and each spectral envelope by using Mel or Burke scales on the frequency axis. By using the series of sound source spectra and the series of spectral envelopes with a reduced number of dimensions for training, it is possible to reduce the data size of the generative model M and improve learning efficiency.

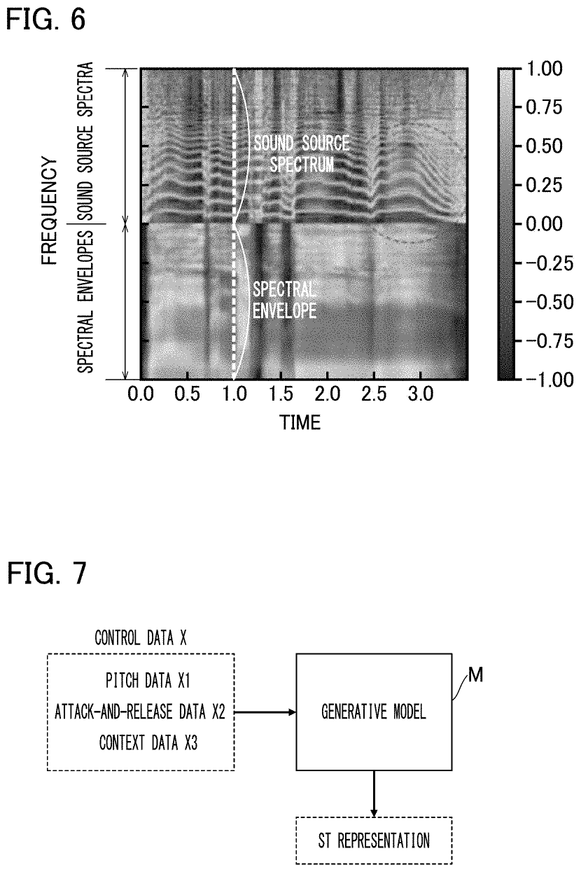

FIG. 5 shows an example of a series of waveform spectra of a sound signal in the Mel scale. In FIG. 5, the horizontal axis represents a time axis, the vertical axis represents a frequency axis, and the dashed line represents a waveform spectrum at a certain time on the time axis. FIG. 6 shows an example of a series of ST representations for the sound signal in the Mel scale. The upper part of FIG. 6 represents the series of the sound source spectra. In the upper part, the horizontal axis represents a time axis, the vertical axis represents a frequency axis, and the dashed line represents a sound source spectrum at a certain time on the time axis. The lower part of FIG. 6 represents the series of the spectral envelopes. In the lower part, the horizontal axis represents a time axis, the vertical axis represents a frequency axis, and the dashed line represents a spectral envelope at a certain time on the time axis.

The analyzer 111 can reduce the number of dimensions of the series of sound source spectra and the series of spectral envelopes by using the Mel or Burke scales separately, or can reduce the number of dimensions of either the series of sound source spectra or the series of spectral envelopes.

The time aligner 112 shown in FIG. 2 aligns, based on information such as a series of waveform spectra obtained by the analyzer 111, start and end points of each of sound production units in score data for each reference signal R, with start and end points of a waveform segment corresponding to a sound production unit in the reference signal R. A sound production unit is, for example, a single note having a specified pitch and sound duration. A single note can be divided into more than one sound production unit by dividing the note at a point where waveform characteristics, such as those of tone, change.

The condition generator 113 generates, based on the information of the sound production units of the score data, timings of which are aligned with those in each reference signal R, control data X for each time t in each frame to output the generated control data X to the trainer 115, the control data X corresponding to the waveform segment of the time t in the reference signal R. The control data X specifies the conditions of a sound signal V to be synthesized, as described above. The control data X includes pitch data X1, attack-and-release data X2, and context data X3, as shown in FIG. 7. The pitch data X1 represents a pitch of a corresponding waveform segment. The attack-and-release data X2 represents a start period (an attack) and an end period (a release) of each waveform segment. The pitch data X1 can include a variation in pitch due to pitch bend or vibrato. The context data X3 of one frame in a waveform segment corresponding to one note represents relations (i.e., context) between one sound production unit and another sound production unit before and/or after the sound production unit, such as a difference in pitch between two different notes that are next to each other. The control data X can also contain other information such as that pertaining to instruments, singers, or techniques. Data used for training the generative model M (hereafter, “sound production unit data”) are obtained for each sound production unit, from the reference signals R and score data of different reference signals R. Sound production unit data comprises a set of (i) control data X, and (ii) a sound source spectrum and a spectral envelope.

In some cases, regarding a sound production unit for a context, the obtained sound production unit data alone cannot be sufficient to cover all of the pitches of a sound signal V to be synthesized. The augmentor 114 shown in FIG. 2 supplements sound production unit data for a pitch that is missing from the obtained sound production unit data, by augmentation of the reference signal R. Specifically, in a case that production unit data for a certain pitch is missing, the augmentor 114 searches for one or more sound production units for pitches close to the missing pitch from among existing sound production units indicated by control data X from the condition generator 113. Thereafter, the augmentor 114 generates, using a waveform segment and sound production unit data that correspond to sound production units found in the search, data X and an ST representation (a sound source spectrum and a spectral envelope) of sound production unit data for the subject pitch.

A series of spectral envelopes are not greatly changed by changes in pitch. Accordingly, the augmentor 114 can use the spectral envelope as it is as a spectral envelope for the missing pitch. Alternatively, in a case that multiple sound production units are found that each have a pitch close to a missing pitch, the augmentor 114 can interpolate or morph the spectral envelopes of the sound production units, to obtain the spectral envelope of the missing pitch.

In contrast, a series of sound source spectra change depending on a pitch (fundamental frequency). Accordingly, it is necessary to generate a sound source spectrum of a pitch (hereafter, “second pitch”) by performing pitch change on a sound source spectrum of the sound production unit of another pitch (hereafter, “first pitch”).

Specifically, by use of a pitch change technique disclosed in U.S. Pat. No. 9,286,906 B2 (corresponding to Japanese Patent No. 5,772,739), which is herein incorporated by reference, a series of sound source spectra in the second pitch can be calculated by changing a series of sound source spectra in the first pitch while maintaining the components between the harmonics. By this pitch change technique, near each harmonic component of a spectrum, sideband spectral components (subharmonics) are generated by frequency modulation or amplitude modulation. Even after the pitch change, differences between the frequencies of sideband spectral components and the frequencies of the harmonic components are retained as they are in the series of sound source spectra of the first pitch.

Alternatively, the following pitch change can be used by the augmentor 114. First, the augmentor 114 resamples a waveform segment corresponding to the sound source spectrum in the first pitch, for use as a waveform segment corresponding to the sound source spectrum in the second pitch. Next, the augmentor 114 applies the short-time Fourier transform to the obtained waveform segment, to calculate a spectrum for each frame. The augmentor 114 then applies to the calculated series of spectra a reverse expansion/compression to cancel a time-expansion/compression caused by resampling. Further, the augmentor 114 applies whitening to the series of spectra obtained by the reverse expansion/compression, using the series of spectral envelopes thereof. In this case, by sampling the reference signal R at a sampling rate higher than that at the synthesis, it is possible to maintain high frequency components even if the pitch is lowered by resampling. By this method, the modulation frequency is subject to conversion with the same ratio as used in the pitch change. In a case that a waveform to be processed has a pitch period that is a constant multiple of the modulation period, it is possible to calculate a sound source spectrum that corresponds to the sound source spectrum obtained by the pitch change where the relation between the pitch period and the modulation frequency is maintained.

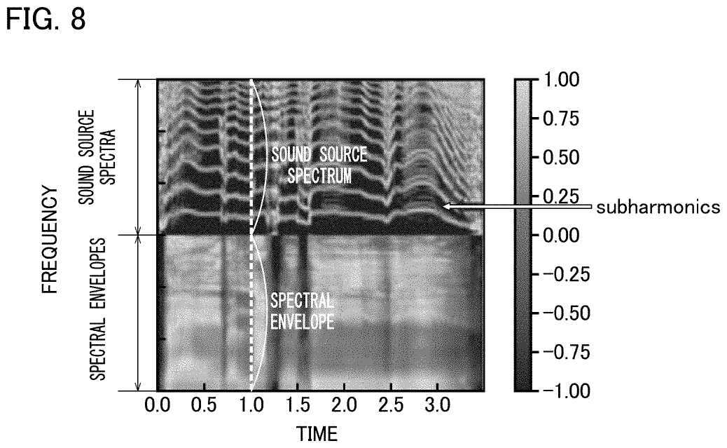

FIG. 8 shows a series of ST representations in a pitch (second pitch) generated by the augmentor 114 from the series of ST representations (FIG. 6) for a specific pitch (first pitch). The second pitch is higher than the first pitch. A series of sound source spectra in the second pitch, shown in the upper part of FIG. 8, is obtained by applying the pitch change to the series of sound source spectra in the first pitch shown in FIG. 6. In the upper part, the horizontal axis represents a time axis, the vertical axis represents a frequency axis, and the dashed line represents a sound source spectrum at a certain time on the time axis. A series of spectral envelopes shown in the lower part of FIG. 8 is the same as that shown in FIG. 6. In the lower part, the horizontal axis represents a time axis, the vertical axis represents a frequency axis, and the dashed line represents a spectral envelope at a certain time on the time axis. As shown in the upper part of FIG. 8, in the series of sound source spectra after the pitch change, the sideband spectral components between harmonic components are maintained.

To obtain control data X for the second pitch, control data X for a pitch close to the second pitch is used, and the control data X for the second pitch is obtained by changing the values of pitch data X1 for the control data X to values equivalent to the second pitch. In the above manner, the augmentor 114 generates sound production unit data for the second pitch, for which sound production unit data to be used for training is missing. The sound production unit data for the second pitch includes control data X for the second pitch, and an ST representation (a sound source spectrum and a spectral envelope) for the second pitch.

In the process described thus far, sound production unit data for different pitches (including the second pitch) within an intended pitch range are prepared from the reference signals R and from the score data for the reference signals R. Each sound production unit data comprises a set of control data X and an ST representation. The sound production unit data are divided, prior to training by the trainer 115, into a training dataset for training the generative model M and a test dataset for testing the generative model M. A majority of the sound production unit data are used as a training dataset with the remainder being used as a test dataset. Training with the training dataset is performed by dividing the sound production unit data into batches, with each batch consisting of a predetermined number of frames, and the training is performed on a per-batch-basis in order for each of the batches.

As shown in FIG. 7, the trainer 115 receives the training dataset to train the generative model M by using in turn the ST representation and the control data X of the sound production units in each batch. The generative model M in the first embodiment comprises a single neural network, and generates the following (i) and (ii) in parallel at each time t: (i) first data representative of a sound source spectrum of an ST representation; and (ii) second data representative of a spectral envelope of the ST representation.

The trainer 115 inputs into the generative model M the control data X for pronunciation unit data for one batch, to generate a series of first data and a series of second data for the control data X. The trainer 115 calculates a loss function LS (cumulative value for one batch) based on the following (i) and (ii): (i) a sound source spectrum indicative of the first data generated by the generative model M; and (ii) a ground-truth that is a sound source spectrum of the corresponding ST representation in the training dataset. Further, the trainer 115 calculates a loss function LT (cumulative value for one batch) based on the following (i) and (ii): (i) a spectral envelope indicative of the second data generated by the generative model M; and (ii) a ground-truth that is a spectral envelope for the corresponding ST representation in the training dataset. Thereafter, the trainer 115 optimizes the variables of the generative model M such that the loss function L is minimized. The loss function L is represented by a weighted sum of the loss functions LS and LT. Examples of the loss functions LS and LT include a cross entropy function and a squared error function. The trainer 115 repeats the above training using the training dataset until the loss function L calculated for the test dataset is reduced to a sufficiently small value, or a change between two consecutive loss functions L is sufficiently reduced.

The established generative model M has learned a relationship potentially existing between the control data X for the sound production unit data, and the ST representation data corresponding to the control data X. By use of this generative model M, the generator 122 can generate high quality ST components for control data X′ for an unknown sound signal V.

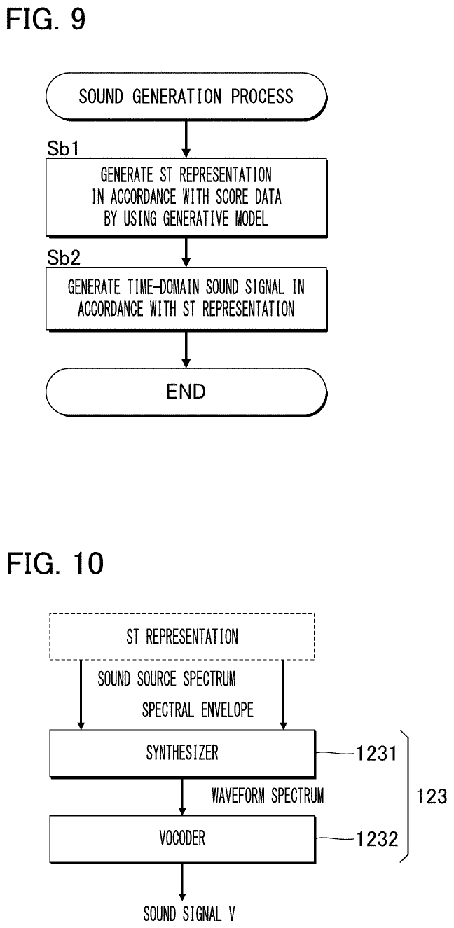

Next, description will be given of a sound generation function, shown in FIG. 2, that generates a sound signal V using the generative model M. The sound generation function is realized by execution of a sound generation process by the control device 11, as shown in a flowchart in FIG. 9. In one example, the sound generation process is initiated by an instruction from the user of the sound signal synthesis system 100.

When the sound generation process is started, the control device 11 (implemented by the generation controller 121, and the generator 122) uses the generative model M to generate an ST representation (a sound source spectrum and a spectral envelope) in accordance with control data X generated from score data (Sb1). Next, the control device 11 (implemented by a converter 123) synthesizes a sound signal V in accordance with the generated a series of ST representations (Sb2).

Detailed description will now be given of these functions of the sound generation process. The generation controller 121 shown in FIG. 2 generates control data X′ for each time t, based on a series of sound production units of the score data to be played back, and outputs the generated data to the generator 122. As with the control data X described above, the control data X′ represents states of the sound production unit at each time t of the score data, and includes (i) a pitch data X1′, (ii) attack-and-release data X2′, and (iii) context data X3′.

The generator 122 generates a series of sound source spectra and a series of spectral envelopes in accordance with the control data X′, using the generative model M trained in the above described preparation process. As shown in FIG. 2, the generator 122 uses the generative model M to generate the following (i) and (ii) in parallel for each frame (for each time t): (i) first data representative of a sound source spectrum corresponding to the control data X′; and (ii) second data representative of a spectral envelope corresponding to the control data X′.

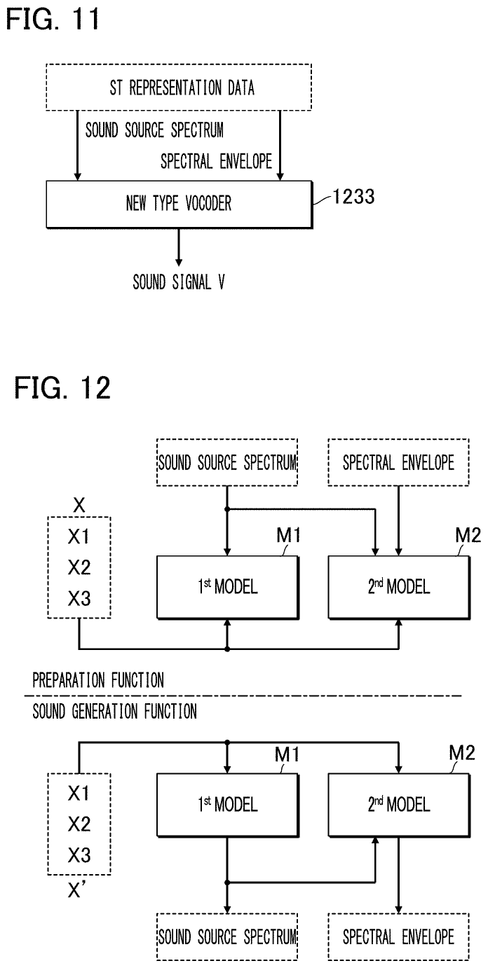

The converter 123 receives the series of ST representations (a series of sound source spectra and a series of spectral envelopes) generated by the generator 122, and converts the received series of ST representations into a time-domain sound signal V. Specifically, as shown in FIG. 10, the converter 123 includes a synthesizer 1231 and a vocoder 1232. The synthesizer 1231 generates a waveform spectrum by synthesizing (or adding if using a logarithmic scale) each sound source spectrum and a corresponding spectral envelope. The vocoder 1232 applies short-time inverse Fourier transform to (i) the waveform spectrum and (ii) a phase spectrum obtained as the minimum phase from the waveform spectrum, to generate a sound signal V in the time domain. Instead of the general vocoder 1232, a new type vocoder 1233 can be used. The vocoder 1233 uses a generative model M (e.g., a neural network) that has learned the relationship between the series of ST representations and samples of the sound signal V, as shown in FIG. 11.

### B: Second Embodiment

The second embodiment will now be described. In the embodiments shown in the following, elements having the same functions as in the first embodiment are denoted by the same reference numerals as used for like elements in the description of the first embodiment, and detailed description thereof is omitted as appropriate.

In the first embodiment, an example of a single generative model M is illustrated in which each sound source spectrum and each spectral envelope are generated together. Alternatively, as shown in FIG. 12, two different generative models can be provided in which the series of sound source spectra are generated independently from the series of spectral envelopes. The functional structure of the second embodiment is identical to that of the first embodiment (shown in FIG. 2). The generative models in the second embodiment comprise a first model M1 and a second model M2. The generator 122 in the second embodiment uses the first model to generate a sound source spectrum in accordance with control data X. Further, the generator 122 uses the second model to generate a spectral envelope in accordance with the control data X and the generated sound source spectrum.

In the preparation process shown in the upper part of FIG. 12, the trainer 115 inputs into the first model control data X in each batch of the training dataset, to generate first data representative of a series of sound source spectra in accordance with the control data X. Next, on the basis of (i) the series of sound source spectra indicated by the generated first data, and (ii) ground-truths that are a series of sound source spectra in the training dataset, the trainer 115 calculates the loss function LS of the batch, and optimizes the variables of the first model such that the loss function LS is minimized.

Further, the trainer 115 calculates inputs into the second model the control data X of the training dataset and a series of sound source spectra of the training dataset, to generate second data representative of a series of spectral envelopes in accordance with the control data X and a series of sound source spectra. Next, the trainer 115 calculates the loss function LT of the batch, based on (i) a series of spectral envelopes indicated by the generated second data; and (ii) ground-truths that are a series of spectral envelopes in the training dataset. The trainer 115 then optimizes the variables of the second model such that the loss function LT is minimized.

The established first model has learned the relationship that potentially exists between (i) control data X in sound production unit data, and (ii) first data representative of the series of sound source spectra of the reference signals R. Further, the established second model has learned the relationship that potentially exists between (i) first data representative of a sound source spectrum and control data X, in the sound production unit data, and (ii) a spectral envelope of the reference signal R.

By use of these generative models M1, M2, the generator 122 is able to generate a sound source spectrum and a spectral envelope for unknown control data X′. The spectral envelope has a shape corresponding to the control data X′, and is in synchronization with the sound source spectrum.

In the sound generation process shown in the lower part of FIG. 12, similarly to the first embodiment, the condition generator 113 generates control data X′ in accordance with score data. The generator 122 uses the first model to generate first data representative of the sound source spectrum in accordance with the control data X′. Further, the generator 122 uses the second model, to generate (i) second data representative of the spectral envelope in accordance with the control data X′ and (ii) the sound source spectrum indicated by the first data. In other words, a ST representation (a sound source spectrum and a spectral envelope) indicated by the first data and the second data is generated. Similarly to the first embodiment, the converter 123 converts the generated series of ST representations into a sound signal V.

In the second embodiment, control data X supplied to the first model can differ from the control data X supplied to the second model, depending on data characteristics generated by each model. Specifically, given that a change in a sound source spectrum resulting from change in a pitch is greater than that in a spectral envelope resulting from change in the pitch, it is preferable that pitch data X1a for input into the first model have a high resolution, and that pitch data X1b for input into the second model have a resolution lower than that of the pitch data X1a. Further, given that a change in a spectral envelope resulting from change in a context is greater than that in a sound source spectrum resulting from a change in context, it is preferable that context data X3b for input into the second model have a high resolution, and that context data X3a for input into the first model have a resolution lower than that of the context data X3b. In this way the amount of data required for the first and second models can be reduced with minimal effect on the quality of the generated series of ST representations (sound quality of the synthesized sound).

In addition, in the second embodiment, the series of sound source spectra are generated independently from the series of spectral envelopes. Here, dependence of the series of sound source spectra on a sound source tends to be greater than that of the series of spectral envelopes on the sound source. Accordingly, the augmentor 114 can supplement data missing for a pitch change only for a sound source spectrum that has a large dependence on a pitch, and not for a spectral envelope that has a small dependence on the pitch. This enables a processing load on the augmentor 114 to be reduced.

### C: Third Embodiment

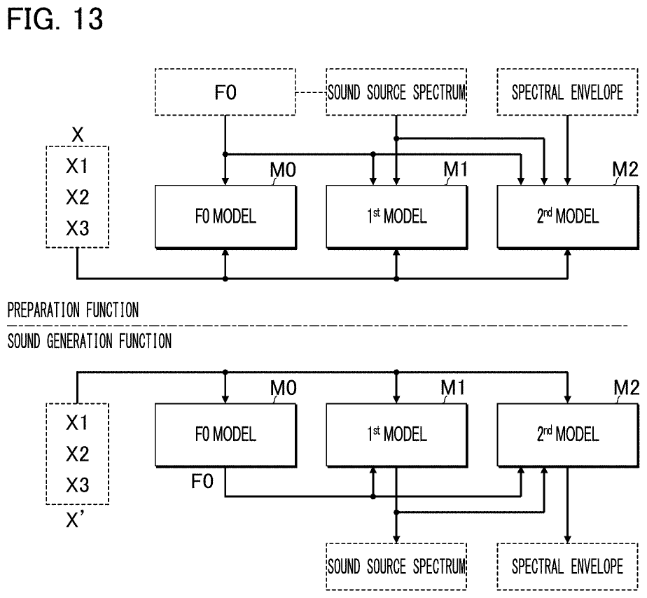

FIG. 13 is a block diagram showing an example of a functional configuration of the sound signal synthesis system 100 in the third embodiment. A generative model in the third embodiment includes an F0 model M0 for generating a pitch, in addition to the first model M1 for generating the series of sound source spectra and the second model M2 for generating the series of spectral envelopes. The F0 model M0 generates pitch data representative of a pitch (a fundamental frequency) in accordance with control data X. The first model M1 generates a sound source spectrum in accordance with the control data X and the pitch data. The second model M2 generates a spectral envelope in accordance with the control data X, the pitch and the sound source spectrum.

In the preparation process shown in the upper part of FIG. 13, the trainer 115 trains the F0 model using a training dataset and a test dataset, such that the F0 model M0 generates pitch data indicative of a pitch F0 in accordance with control data X′. Further, the trainer 115 trains the first model M1 such that the first model M1 generates a sound source spectrum in accordance with the control data X′ and the pitch F0. In addition, the trainer 115 trains the second model M2 such that the second model M2 generates a spectral envelope in accordance with the control data X′, the pitch F0 and the sound source spectrum. The F0 model M0 established by the preparation process has learned the relationship that potentially exists between the control data X and the pitches F0. The first model M1 has learned the relationship that potentially exists between (i) the control data X and the pitches F0 and (ii) the series of sound source spectra. The second model M2 has learned the relationship that potentially exists between (i) the control data X, the pitches F0, the series of sound source spectra and (ii) the series of spectral envelopes.

In the sound generation process shown in the lower part of FIG. 13, similarly to the first embodiment, the condition generator 113 generates control data X′ in accordance with score data. First, the generator 122 generates a pitch F0 in accordance with the control data X′, using the F0 model M0. Next, the generator 122 generates a sound source spectrum in accordance with the control data X′ and the generated pitch F0, using the first model M1. Further, the generator 122 generates a spectral envelope in accordance with the control data X′, the pitch F0, and the generated sound source spectrum, using the second model M2. The converter 123 converts the generated series of sound source spectra and the series of spectral envelopes (i.e., the generated series of ST representations) into a sound signal V.

In the third embodiment, similarly to the second embodiment, since the series of sound source spectra and the series of spectral envelopes are synchronized with each other, high quality ST representations can be generated. In addition, since pitches are taken into account in both the first and second models M1, M2, changes in pitch can be reflected in the series of ST representations.

### D: Fourth Embodiment

In the first embodiment shown in FIG. 2, a sound generation function is illustrated in which a sound signal V is generated based on the information of a series of sound production units in score data. However, a sound signal V can be generated in real time based on the information of sound production units supplied from a musical keyboard or the like. The generation controller 121 generates control data X and control data Y for each time point, based on information of the sound production units supplied up to each time point. In this case, it is not practically possible to include information of a future sound production unit in the context data X3 contained in the control data X; however, information of a future sound production unit can be predicted from past information and included in the context data X3.

A sound signal V synthesized by the sound signal synthesis system 100 is not limited to instrumental sounds or voices. Any sound that contains a stochastic element in a process of generating a sound, such as animal voices or sounds of nature (e.g., a sound of wind, a sound of wave, etc.) can be synthesized by the sound signal synthesis system 100.

The foregoing functions of the sound signal synthesis system 100 are realized by the cooperation of single or multiple processors constituting the control device 11 and the program stored in the storage device 12. The program of the present disclosure can be stored in a computer-readable recording medium, and this recording medium can be distributed and installed on a computer.

In one example, the recording medium is a non-transitory recording medium, preferable examples of which include an optical recording medium (optical disc), such as a CD-ROM. However, the recording medium can be any recording medium, such as a semiconductor recording medium or a magnetic recording medium. Here, the concept of the non-transitory recording medium includes any recording medium except transitory, propagating signals. Volatile recording mediums are not excluded. In a case where a distribution apparatus distributes the program via a communication network, the non-transitory recording medium corresponds to a storage device that stores the program in the distribution apparatus.

### DESCRIPTION OF REFERENCE SIGNS

100 . . . sound signal synthesis system, 11 . . . control device, 12 . . . storage device, 13 . . . display device, 14 . . . input device, 15 . . . sound output device, 111 . . . analyzer, 1111 . . . whitening processor, 1112 . . . extractor, 112 . . . time aligner, 113 . . . condition generator, 114 . . . expander, 115 . . . trainer, 121 . . . generation controller, 122 . . . generator, 123 . . . converter.

What is claimed is:

1. A computer-implemented sound signal synthesis method comprising:
generating, based on first control data representative of a plurality of conditions of a sound signal to be generated, (i) first data representative of a sound source spectrum of the sound signal, and (ii) second data representative of a spectral envelope of the sound signal; and
synthesizing the sound signal based on the sound source spectrum indicated by the first data and the spectral envelope indicated by the second data.

2. The computer-implemented sound signal synthesis method according to claim 1, wherein the first data and the second data are generated by inputting the first control data into a generative model.

3. The computer-implemented sound signal synthesis method according to claim 2, wherein the generative model is a trained model that has learned a relationship between (i) second control data representative of a plurality of conditions of a reference signal as input data to the generative model, and (ii) third data representative of a sound source spectrum of the reference signal and fourth data representative of a spectral envelope of the reference signal as output data from the generative model.

4. The computer-implemented sound signal synthesis method according to claim 1,
wherein the first data is generated by inputting the first control data into a first model, and
wherein the second data is generated by inputting the control data and the generated first data into a second model.

5. The computer-implemented sound signal synthesis method according to claim 4, wherein the first model is a trained model that has learned a relationship between (i) second control data representative of a plurality of conditions of a reference signal as input data to the trained model, and (ii) third data representative of a sound source spectrum of the reference signal as output data from the trained model.

6. The computer-implemented sound signal synthesis method according to claim 4, wherein the second model is a trained model that has learned a relationship between (i) second control data representative of a plurality of conditions of a reference signal and third data representative of a sound source spectrum of the reference signal as input data to the trained model, and (ii) fourth data representative of a spectral envelope of the reference signal as output data to the trained model.

7. The computer-implemented sound signal synthesis method according to claim 1, further comprising:
generating, based on the first control data, pitch data representative of a pitch of the sound signal,
wherein the first data is generated by inputting, into a first model, the first control data and the generated pitch data, and
wherein the second data is generated by inputting, into a second model, the first control data, the generated pitch data, and the generated first data.

8. A computer-implemented generative model training method comprising:
obtaining, from a waveform spectrum of a reference signal, a spectral envelope representative of an envelope of the waveform spectrum;
obtaining a sound source spectrum by applying whitening to the waveform spectrum, using the spectral envelope; and
training a generative model that includes at least one neural network,
wherein the generative model is trained to generate, based on first control data representative of a plurality of conditions of the reference signal, first data representative of the sound source spectrum and second data representative of the spectral envelope.

9. The computer-implemented generative model training method according to claim 8,
wherein the sound spectrum corresponds to a first pitch, and
wherein the method further comprises:
pitch-changing the sound source spectrum corresponding to the first pitch into a sound source spectrum corresponding to a second pitch;
generating second control data indicating the second pitch by changing a pitch indicated by the first control data from the first pitch to the second pitch; and
training the generative model to generate, based on the second control data, third data representative of the sound source spectrum corresponding to the second pitch.

10. A sound signal synthesis system comprising:
at least one processor communicatively connected to a memory and configured to execute a program to:
generate, based on first control data representative of a plurality of conditions of a sound signal to be generated, (i) first data representative of a sound source spectrum of the sound signal, and (ii) second data representative of a spectral envelope of the sound signal; and
synthesize the sound signal based on the sound source spectrum indicated by the first data and the spectral envelope indicated by the second data.

11. The sound signal synthesis system according to claim 10, wherein the first data and the second data are generated by inputting the first control data into a generative model.

12. The sound signal synthesis system according to claim 11, wherein the generative model is a trained model that has learned a relationship between (i) second control data representative of a plurality of conditions of a reference signal as input data to the trained model, and (ii) third data representative of a sound source spectrum of the reference signal and fourth data representative of a spectral envelope of the reference signal as output data from the trained model.

13. The sound signal synthesis system according to claim 10,
wherein the first data is generated by inputting the first control data into a first model; and
wherein the second data is generated by inputting the first control data and the generated first data into a second model.

14. The sound signal synthesis system according to claim 13, wherein the first model is a trained model that has learned a relationship between (i) second control data representative of a plurality of conditions of a reference signal as input data to the trained model, and (ii) third data representative of a sound source spectrum of the reference signal as output data from the trained model.

15. The sound signal synthesis system according to claim 13, wherein the second model is a trained model that has learned a relationship between (i) second control data representative of a plurality of conditions of a reference signal and third data representative of a sound source spectrum of the reference signal as input data to the trained model, and (ii) fourth data representative of a spectral envelope of the reference signal as output data from the trained model.

16. The sound signal synthesis system according to claim 10,
wherein the at least one processor is further configured to execute the program to generate, based on the first control data, pitch data representative of a pitch of the sound signal,
wherein the first data is generated by inputting, into a first model, the first control data and the generated pitch data, and
wherein the second data is generated by inputting, into a second model, the first control data, the generated pitch data, and the generated first data.

17. A non-transitory recording medium for storing a program implemented by a computer to execute a method comprising:
generating, based on first control data representative of a plurality of conditions of a sound signal to be generated, (i) first data representative of a sound source spectrum of the sound signal, and (ii) second data representative of a spectral envelope of the sound signal; and
synthesizing the sound signal based on the sound source spectrum indicated by the first data and the spectral envelope indicated by the second data.
